(19) United States
(12) Patent Application Publication
(10) Pub. No.: US 2025/0358778 A1
(43) Pub. Date: Nov. 20, 2025

(54) UE, BS AND NETWORK NODE FOR WIRELESS COMMUNICATION

(71) Applicant: GUANGDONG OPPO MOBILE TELECOMMUNICATIONS CORP., LTD., Dongguan (CN)

(72) Inventor: Hao LIN, Neuilly-sur-Seine (FR)

(21) Appl. No.: 19/286,187

(22) Filed: Jul. 30, 2025

Related U.S. Application Data
(63) Continuation of application No. PCT/IB2023/000103, filed on Feb. 2, 2023.

(51) Int. Cl. H04W 64/00; H04L 5/00; H04W 56/00

(52) U.S. Cl. CPC H04W 64/00; H04L 5/0051; H04W 56/0045

(57) ABSTRACT

A user equipment (UE) for wireless communication is provided in the present disclosure. The UE includes: a memory, a transceiver, and a processor coupled to the memory and the transceiver; wherein the UE is configured to report a UE assistance data associated with a UE time difference to a network node and/or a base station (BS).

### CROSS-REFERENCE TO RELATED APPLICATION

This application is a continuation of International Application No. PCT/IB2023/000103, filed Feb. 2, 2023, the entire disclosure of which is incorporated herein by reference.

### BACKGROUND

### 1. Field of the Disclosure

The present disclosure relates to the field of communication systems, and more particularly, to a user equipment (UE), a base station (BS) and a network node for wireless communication.

### 2. Description of the Related Art

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as long term evolution (LTE) systems, LTE-advanced (LTE-A) systems, or LTE-A pro systems, and fifth generation (5G) systems which may be referred to as new radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

In wireless communications systems, timing advance (TA) values corresponding to different times may be quite different. Therefore, there is a need for an apparatus and a method of wireless communication for positioning.

### SUMMARY

An object of the present disclosure is to propose an apparatus and a method of a UE, a BS and a network node for wireless communication.

In some embodiments of the present disclosure, a user equipment (UE) includes a memory, a transceiver, and a processor coupled to the memory and the transceiver. The processor is configured to: report a UE assistance data associated with a UE time difference to a network node and/or a base station (BS).

In some embodiments of the present disclosure, a base station (BS) includes a memory, a transceiver, and a processor coupled to the memory and the transceiver. The processor is configured to: report a BS assistance data associated with a BS time difference to a network node.

In some embodiments of the present disclosure, a network node includes a memory, a transceiver, and a processor coupled to the memory and the transceiver. The transceiver is configured to receive a UE assistance data associated with a UE time difference from a UE and/or receive a BS assistance data associated with a BS time difference from a BS.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic structural diagram of a communication system according to an embodiment of the present application.

FIG. 1B is a schematic structural diagram of another communication system according to an embodiment of the present application.

FIG. 1C is a schematic structural diagram of another communication system according to an embodiment of the present application.

FIG. 2A is a schematic diagram of signal transmission in a multi-RTT positioning method according to an embodiment of the present application.

FIG. 2B is a schematic diagram of signal transmission in a multi-RTT positioning method according to an embodiment of the present application.

FIG. 3 is a schematic diagram of signal transmission in a multi-RTT positioning method according to an embodiment of the present application.

FIG. 4 is a block diagram of one or more user equipments (UEs) and a network device of communication in a communication network system according to an embodiment of the present disclosure.

FIG. 5 is a flowchart illustrating a method of wireless communication performed by a user equipment (UE) according to an embodiment of the present disclosure.

FIG. 6 is a flowchart illustrating a method of wireless communication performed by a base station (BS) according to an embodiment of the present disclosure.

FIG. 7 is a flowchart illustrating a method of wireless communication performed by a network node according to an embodiment of the present disclosure.

FIG. 8 is a block diagram of a UE and a network device of communication in a communication network system (e.g., non-terrestrial network (NTN)) according to an embodiment of the present disclosure.

FIG. 9 is a block diagram of a UE and a network device of communication in a communication network system (e.g., non-terrestrial network (NTN)) according to an embodiment of the present disclosure.

FIG. 10A is a block diagram of a UE and a network device of communication in a communication network system (e.g., non-terrestrial network (NTN)) according to an embodiment of the present disclosure.

FIG. 10B is a block diagram of a UE and a network device of communication in a communication network system (e.g., non-terrestrial network (NTN)) according to an embodiment of the present disclosure.

FIG. 10C is a block diagram of a UE and a network device of communication in a communication network system (e.g., non-terrestrial network (NTN)) according to an embodiment of the present disclosure.

FIG. 10D is a block diagram of a UE and a network device of communication in a communication network system (e.g., non-terrestrial network (NTN)) according to an embodiment of the present disclosure.

FIG. 11 is a schematic diagram of a topology of NTN positioning according to an embodiment of the present disclosure.

FIG. 12 is a schematic diagram of a communication network system positioning according to an embodiment of the present disclosure.

FIG. 13 is a schematic diagram of a communication network system positioning according to an embodiment of the present disclosure.

FIG. 14 is a flowchart illustrating a communication network system positioning according to an embodiment of the present disclosure.

FIG. 15 is a flowchart illustrating a communication network system positioning according to an embodiment of the present disclosure.

FIG. 16 is a block diagram of a wireless communication device according to an embodiment of the present disclosure.

FIG. 17 is a block diagram of a wireless communication device according to an embodiment of the present disclosure.

FIG. 18 is a block diagram of a wireless communication device according to an embodiment of the present disclosure.

FIG. 19 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5G system (may also be called a new radio (NR) system) or other communication systems, etc.

Optionally, a network device or a network node mentioned in the embodiments of the present application can provide a communication coverage for a specific geographic area and can communicate with a terminal device located in the coverage area. Optionally, the network device may be a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN). Alternatively, the network device may be a relay station, an access point, an in-vehicle device, a wearable device, a network-side device in a future 5G network, or a network device in a future evolved public land mobile network (PLMN).

A terminal device of implementations may be mobile or fixed. The terminal device may refer to an access terminal, a user equipment (UE), a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved PLMN, etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

Optionally, the embodiments of the present application may be applied to a non-terrestrial network (NTN, non-terrestrial communication network) system or a terrestrial network (TN, terrestrial communication network) system.

As an example, in this embodiment of the present application, the network device may have a mobile feature, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station set in a location such as land or water.

Communication system scenarios may include a TN and an NTN. The NTN may use satellite communication to provide communication services to terrestrial users. NTN systems currently include new radio (NR)-NTN systems and internet of things (IoT)-NTN systems.

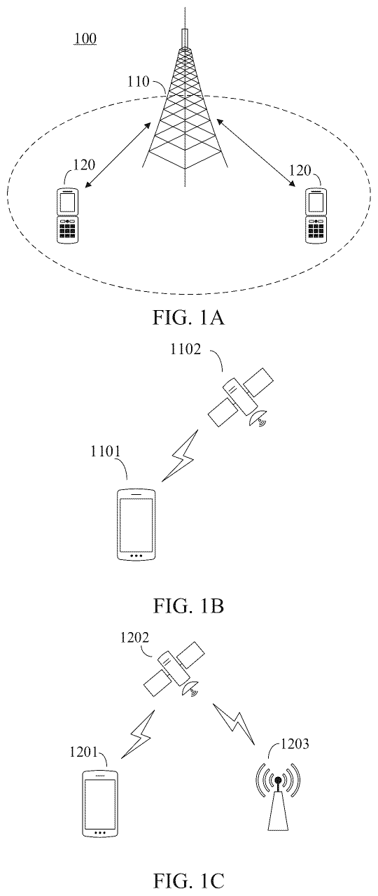

Exemplarily, FIG. 1A is a schematic structural diagram of a communication system according to an embodiment of the present application. As illustrated in FIG. 1A, a communication system 100 may include a network device 110, and the network device 110 may be a device that communicates with a terminal device 120 (or referred to as a communication terminal, a terminal). The network device 110 may provide a communication coverage for a particular geographic area and may communicate with terminal devices located within the coverage area. FIG. 1A exemplarily illustrates one network device and two terminal devices. In some embodiments, the communication system 100 may include multiple network devices, and the coverage of each network device may include other numbers of terminal devices, which is not limited in this embodiment of the present application.

Exemplarily, FIG. 1B is a schematic structural diagram of another communication system according to an embodiment of the present application. Referring to FIG. 1B, the communication system includes a terminal device 1101 and a satellite 1102, and wireless communication can be performed between the terminal device 1101 and the satellite 1102. The network formed between the terminal device 1101 and the satellite 1102 may also be referred to as NTN. In the architecture of the communication system illustrated in FIG. 1B, the satellite 1102 can function as a base station, and the terminal device 1101 and the satellite 1102 can communicate directly. Under the system architecture, the satellite 1102 may be referred to as a network device. Optionally, the communication system may include multiple network devices 1102, and the coverage of each network device 1102 may include other numbers of terminal devices, which are not limited in this embodiment of the present application.

Exemplarily, FIG. 1C is a schematic structural diagram of another communication system according to an embodiment of the present application. Referring to FIG. 1C, the communication system includes a terminal device 1201, a satellite 1202, and a base station 1203. The terminal device 1201 and the satellite 1202 can communicate wirelessly, and the satellite 1202 and the base station 1203 can communicate. The network formed between the terminal device 1201, the satellite 1202, and the base station 1203 may also be referred to as NTN. In the architecture of the communication system illustrated in FIG. 1C, the satellite 1202 may not have the function of the base station, and the communication between the terminal device 1201 and the base station 1203 needs to be relayed through the satellite 1202. Under such a system architecture, the base station 1203 may be referred to as a network device. In some embodiments of the present application, the communication system may include multiple network devices 1203, and the coverage of each network device 1203 may include other numbers of terminal devices, which are not limited in this embodiment of the present application.

### NR-NTN and IoT-NTN Synchronization

In the NTN system, the network device needs to send a synchronization assistance information to the terminal device, where the synchronization assistance information is used for the terminal device to complete time domain and/or frequency domain synchronization. The synchronization assistance information is used to indicate at least one of the following information: a serving satellite ephemeris information, a common timing value such as timing advance (TA) parameter, a reference time indication information (epoch time, used to determine time t0), and a duration of a target timer.

The terminal device completes the corresponding time domain and/or frequency domain synchronization according to the synchronization assistance information and at the same time according to its own global navigation satellite system (GNSS) capability. The terminal device may obtain at least one of the following information based on its GNSS capabilities: a terminal device's location, a time reference, and a frequency reference. Furthermore, based on the above information and the information obtained from the synchronization assistance information, the terminal device can obtain a timing and/or frequency offset, and apply a timing advance compensation and/or a frequency offset adjustment in an idle state, an inactive state, or a connected state.

Because the satellite is moving, the synchronization assistance information may change with time. For example, the ephemeris information of a serving satellite may change with time. A public timing value such as a TA parameter can include: a public timing value, a public timing value offset value (such as the first derivative of the common timing value), a rate of change of the offset value of the common timing value (such as the second derivative of the common timing value), etc. The terminal device can determine the serving satellite ephemeris information at different times according to the synchronization assistance information and determine the public TA at different times, so as to obtain timing advance values at different times. That is to say, in the NTN system, the TA values corresponding to different times may be quite different.

In the NR system, the supported positioning methods include a downlink time difference of arrival (DL-TDOA) positioning method, an uplink TDOA (UL-TDOA) positioning method and a multi-round trip time (RTT) positioning method.

The propagation time of a signal is directly related to the propagation distance, so the deviation between the transmission times of the signals sent by multiple network nodes (TRPs) reaching the terminal also reflects the difference between the distances between multiple network nodes and the terminal. The basic principle of the DL-TDOA positioning method is to estimate the position of the terminal based on the transmission time deviation of the signals sent by multiple network nodes (transmission reception points, TRPs) arriving at the terminal and the known positions of the network nodes. The DL-TDOA positioning method is based on the one-way transmission of measurement signals between the network node TRP and the terminal, that is, the network node TRP sends a signal, and the terminal performs measurement.

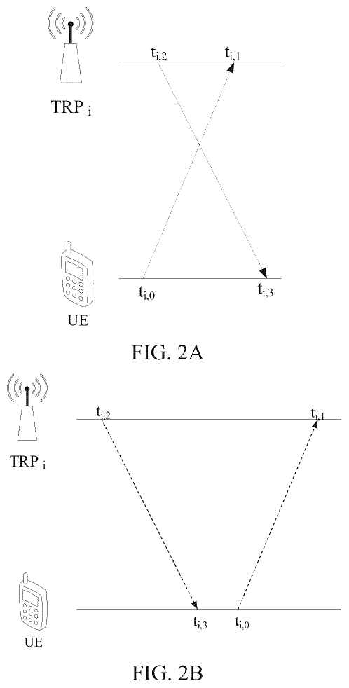

FIG. 2A, FIG. 2B, and FIG. 2C illustrate signal transmission in a multi-RTT positioning method according to an embodiment of the present application. FIG. 2A, FIG. 2B, and FIG. 2C illustrate that, in some embodiments, the basic principle of the multi-RTT positioning method is to estimate the location information of the terminal by corresponding the round-trip arrival (RTT) measurement result to the distance di between the terminal UE and the network node TRP i. The multi-RTT positioning method is based on the two-way transmission of measurement signals between the terminal and the network node TRP, that is, the following two steps are required at the same time: the network node TRP sends a signal, and the terminal performs measurement; the terminal sends a signal, and the network node TRP performs measurement.

The terminal calculates the UE receiving (Rx)-transmit (Tx) time difference (UE Rx-Tx time difference) according to the time when it receives the downlink signal t_{i,3} and the time when it sends the uplink signal t_{i,0}, from/to the network node TRP i (i=1, 2, . . . , M).

$${τ}_{UE , i}^{Rx}$$

indicates receiving timing error of the downlink signal, and

$${τ}_{UE , i}^{Tx}$$

indicates the sending timing error of the terminal sending the uplink signal to the network node TRP i:

$${TD}_{UE Rx - Tx}^{i} = {t}_{i , 3} - {t}_{i , 0} = {\tilde{t}}_{i , 3} + {τ}_{UE , i}^{Rx} - {\tilde{t}}_{i , 0} - {τ}_{UE , i}^{Tx} + {n}_{UE , i} \qquad ( 1 )$$

The network node TRP i calculates the gNB Rx−Tx time difference (gNB Rx−Tx time difference) according to the time when it receives the uplink signal and the time when it sends the downlink signal, where,

$${τ}_{i}^{Rx}$$

represents the network node TRPi (i=1, 2, . . . , M) receiving timing error and of

$${τ}_{i}^{Tx}$$

represents the sending timing error of the network node TRP i:

$${TD}_{gNB Rx - Tx}^{i} = {t}_{i , 1} - {t}_{i , 2} = {\tilde{t}}_{i , 1} + {τ}_{i}^{Rx} - {\tilde{t}}_{i , 2} - {τ}_{i}^{Tx} + {n}_{i} \qquad ( 2 )$$

Summing the equations (1) and (2), the network obtains, assuming

$${τ}_{UE , i}^{Rx} = {τ}_{UE , i}^{Tx} ,$$

the RTT of TRP i being:

$${RTT}_{i} = ( {\tilde{t}}_{i , 1} - {\tilde{t}}_{i , 0} ) + ( {\tilde{t}}_{i , 3} - {\tilde{t}}_{i , 2} ) + ( {n}_{UE , i} + {n}_{i} ) \qquad ( 3 )$$

Equation (3) can be further expressed as di, then Equation can be further expressed as:

$$\frac{{RTT}_{i}}{2} = \frac{{\sqrt[2]{{( {x}_{i} - {x}_{UE} )}^{2} + {( {y}_{i} - {y}_{UE} )}^{2} + {( {z}_{i} - {z}_{UE} )}^{2}}}_{}}{c} + \frac{{n}_{UE , i} + {n}_{i}}{2} \qquad ( 4 )$$

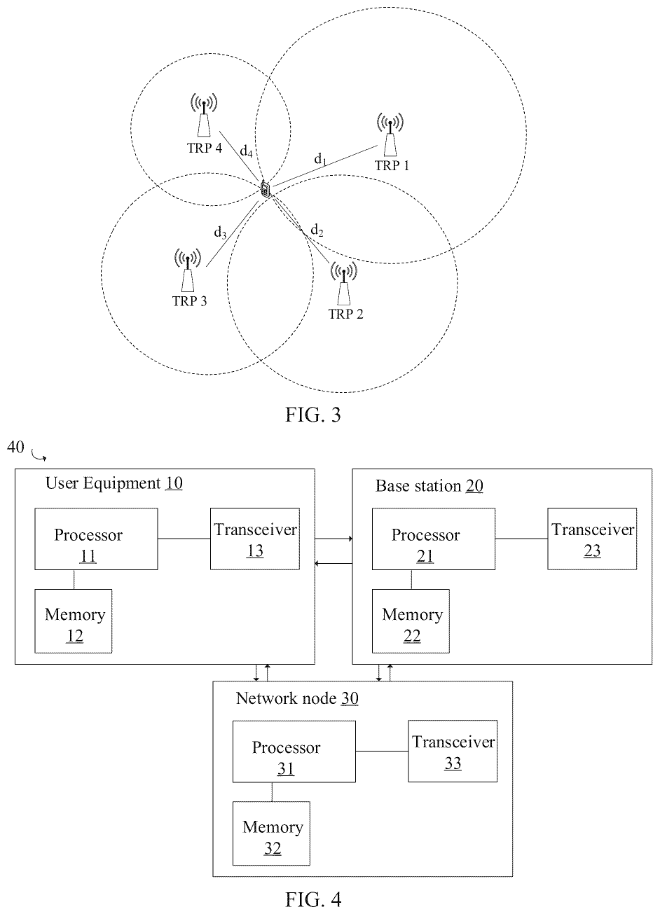

From the RTTi, we can obtain the distance between UE and TRPi and can therefore draw a circle. With multiple RTTs from different TRPs, we can draw multiple circles, the intersection among the circles is the UE location as illustrated in FIG. 3.

FIG. 4 illustrates that, in some embodiments, one or more user equipments (UEs) 10, a base station 20, and a network node 30 in a communication network system 40 (e.g., non-terrestrial network (NTN) or terrestrial network) according to an embodiment of the present disclosure are disclosed. The communication network system 40 includes the one or more UEs 10, the base station 20, and the network node 30. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The network node 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

In some embodiments, the processor 11 is configured to report a UE assistance data associated with a UE time difference to a network node and/or a base station (BS). This can provide a system positioning, reduce a network signaling, reduce a power consumption, provide a good communication performance, and/or provide a high reliability.

In some embodiments, the processor 21 is configured to report a BS assistance data associated with a BS time difference to a network node. This can provide a system positioning, reduce a network signaling, reduce a power consumption, provide a good communication performance, and/or provide a high reliability.

In some embodiments, the transceiver 33 is configured to receive a UE assistance data associated with a UE time difference from a UE; and/or receive a BS assistance data associated with a BS time difference from a BS. This can provide a system positioning, reduce a network signaling, reduce a power consumption, provide a good communication performance, and/or provide a high reliability.

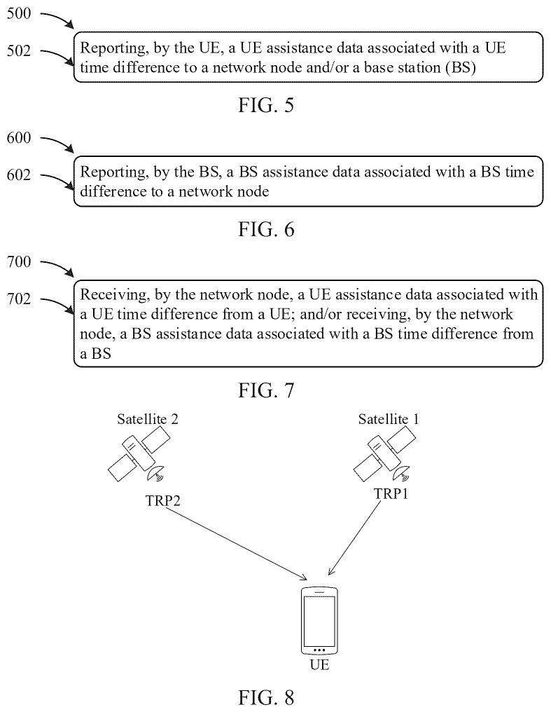

FIG. 5 illustrates a method 500 of wireless communication by a UE according to an embodiment of the present disclosure. In some embodiments, the method 500 includes: a block 502, reporting, by the UE, a UE assistance data associated with a UE time difference to a network node and/or a base station (BS). This can provide a system positioning, reduce a network signaling, reduce a power consumption, provide a good communication performance, and/or provide a high reliability.

FIG. 6 illustrates a method 600 of wireless communication by a network device according to an embodiment of the present disclosure. In some embodiments, the method 600 includes: a block 602, reporting, by the BS, a BS assistance data associated with a BS time difference to a network node. This can provide a system positioning, reduce a network signaling, reduce a power consumption, provide a good communication performance, and/or provide a high reliability.

FIG. 7 illustrates a method 700 of wireless communication by a network device according to an embodiment of the present disclosure. In some embodiments, the method 700 includes: a block 702, receiving, by the network node, a UE assistance data associated with a UE time difference from a UE; and/or receiving, by the network node, a BS assistance data associated with a BS time difference from a BS. This can provide a system positioning, reduce a network signaling, reduce a power consumption, provide a good communication performance, and/or provide a high reliability.

The examples given in this disclosure can be applied for IoT device or NB-IoT UE in NTN systems, but the method is not exclusively restricted to NTN system nor for IoT devices or NB-IoT UE. The examples given in this disclosure can be applied for NR systems, LTE systems, or NB-IoT systems. Further, some examples in the present disclosure can be applied for NB-IoT system, the PDCCH is equivalent to NB-PDCCH (NPDCCH) and the PDSCH is equivalent to NB-PDSCH (NPDSCH).

### Example

In this disclosure, some examples present a method for NTN system positioning using multi-RTT method. The key aspect of examples may include: 1) TRP associate with satellite, 2) UE reporting UE Rx-Tx to location management function (LMF) and/or gNB in the context of NTN system, and/or 3) gNB reporting gNB Rx-Tx to LMF in the context of NTN system.

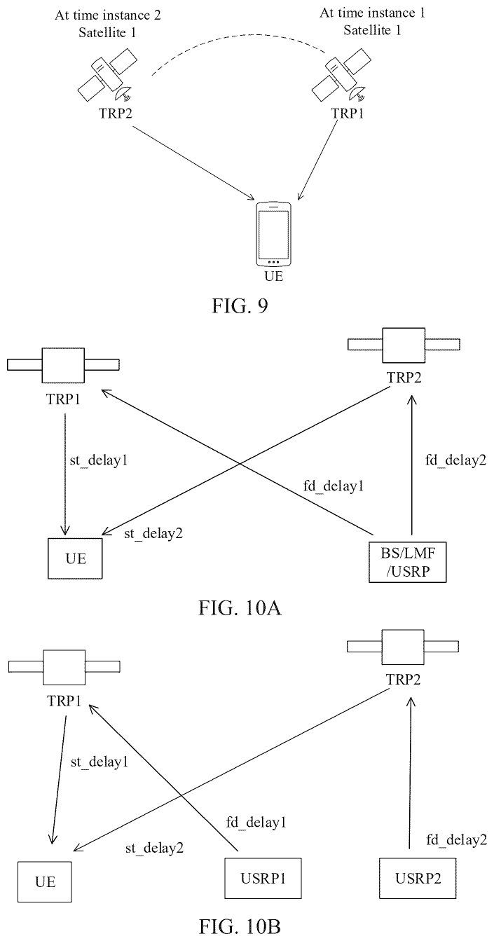

In an NTN system, a TRP may be one satellite and multiple TRPs may be multiple satellites, as illustrated in FIG. 8, optionally, multiple TRPs can also be realized by one satellite, and the satellite at a time instance (or called a time period or a time interval) may be considered as a TRP, thus, the satellite at different time instances may be considered as multiple TRPs as illustrated in FIG. 9. In the following, the presented exemplary method can be applied for one satellite case or multiple satellite case.

Following the legacy DL-TDOA principle, the UE may measure a time delay of arrival difference between two TRPs. In an NTN system with a deployment transparent load, a satellite is used to forward a signal from a base state on ground to a UE or the other way around. Then the signal following two links, i.e., a feeder link and a service link. The feeder link connects the base state/an uplink synchronization reference point (according to TS 38.211 V17.1.0 section 4.1) and the satellite, and the service link connects the satellite and the UE.

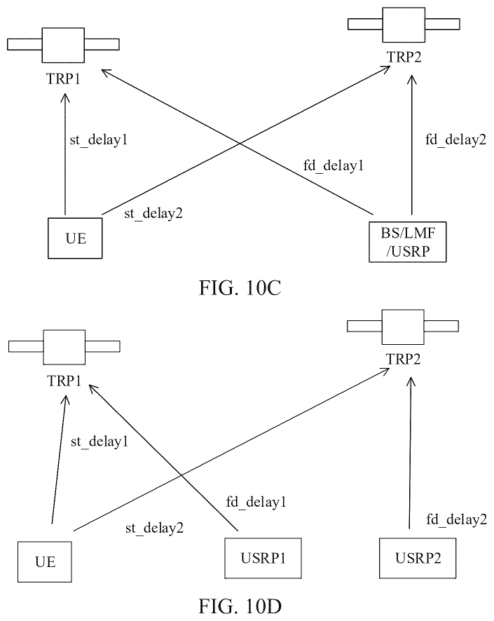

As illustrated in FIG. 10A, when an LMF is installed on the ground, the base state sends a positioning reference signal (PRS) to a satellite, and the satellite then forwards the PRS to a UE. In this case, when the UE receives a PRS from the satellite or from a TRP1, the PRS experiences the delay including a feeder link delay (Fd_delay1) and a service link delay (SL_delay1). When the UE receives another PRS from a TRP2, the PRS experiences Fd_delay2 and SL_delay2. Thus, when the UE calculates the time delay of arrival difference, it turns out that RSTD1=Fd_delay2-Fd_delay1+SL_delay2-SL_delay1. However, since the TRP is on the satellite side, the RSTD only counts for the TDOA between TRP and UE. For this reason, the UE calculates only RSTD2=SL_delay2-SL_delay1. Thus, the UE reports the RSTD2 to the LMF and to calculate the RSTD2. The UE can do the procedures as follows:

In one step, when the UE receives a first PRS from the TRP1, the UE determines a first subframe or slot using the received the first PRS. Then, when the UE receives a second PRS from the TRP2, the UE determines a second subframe or slot using the received the second PRS. The value of RSTD1 is calculated by the time difference between the start of the first subframe and the start of the second subframe.

In another step, the UE determines the value of Fd_delay2-Fd_delay1 by separately determining the value of Fd_delay2 and Fd_delay1, then the UE calculates the value of Fd_delay2-Fd_delay1. The Fd_delay1 is the feeder link delay for TRP1. To calculate the Fe_delay1, the UE may use first one or more parameters provided by the network (such as a core network or a base station) or LMF and/or a first reference time instance to calculate the Fd_delay1. The first reference time instance may be provided by the LMF or the network. In some examples, the first reference time instance is based on the uplink synchronization reference point (or called USRP or RP for short), the uplink synchronization reference point is defined in section 4.1 of TS38.211 V17.1.0. Optionally, the first reference time instance is determined by the UE, where the first reference time instance corresponds to a time instance when the UE receives the first PRS from the TRP1. To calculate the Fe_delay2, the UE may use second one or more parameters provided by the network or LMF and/or a second reference time instance to calculate the Fd_delay2. The second reference time instance may be provided by the LMF or the network. In some examples, the second reference time instance is based on the uplink synchronization reference point. Optionally, the second reference time instance is determined by the UE, where the second reference time instance corresponds to a time instance when the UE receives the second PRS from the TRP2. In some examples, the first one or more parameters are same as the second one or more parameters. For example, when the TRP1 and TRP2 are both from the same satellite, the first one or more parameters are same as the second one or more parameters.

In a third step, the UE calculates the RSTD2, which is based on RSTD1 while subtracting the difference between Fd_delay2 and Fd_delay1, i.e., RSTD2=RSTD1-(Fd_delay2-Fd_delay1). The UE may report the RSTD2 to the LMF.

The operation mechanism of FIG. 10B is similar to the operation mechanism of FIG. 10A, therefore the present disclosure will not repeat the above steps and contents. The difference is that FIG. 10B illustrates that, in some examples, the Fd_delay1 is the feeder link delay for TRP1 from USRP1, and the Fd_delay2 is the feeder link delay for TRP2 from USRP2.

Further, the operation mechanism of FIG. 10C is similar to the operation mechanism of FIG. 10A, therefore the present disclosure will not repeat the above steps and contents. The difference is that FIG. 10C illustrates that, in some examples, the UE transmits a first DRS/URS to the satellite or from a TRP1, and the UE transmits a second DRS/URS to the satellite or from a TRP1. Further, the operation mechanism of FIG. 10D is similar to the operation mechanism of FIG. 10B, therefore the present disclosure will not repeat the above steps and contents. The difference is that FIG. 10C illustrates that, in some examples, the UE transmits a first DRS/URS to the satellite or from a TRP1, and the UE transmits a second DRS/URS to the satellite or from a TRP1.

Optionally, the UE may also report a time stamp to the LMF, where the time stamp refers to a time instance when the UE calculates the RSTD2. The time stamp may be a UTC time or may be a SFN index and/or a slot index. When the time stamp is a SFN index and/or a slot index, the SFN index and/or the slot index are based on the timing at the uplink synchronization reference point.

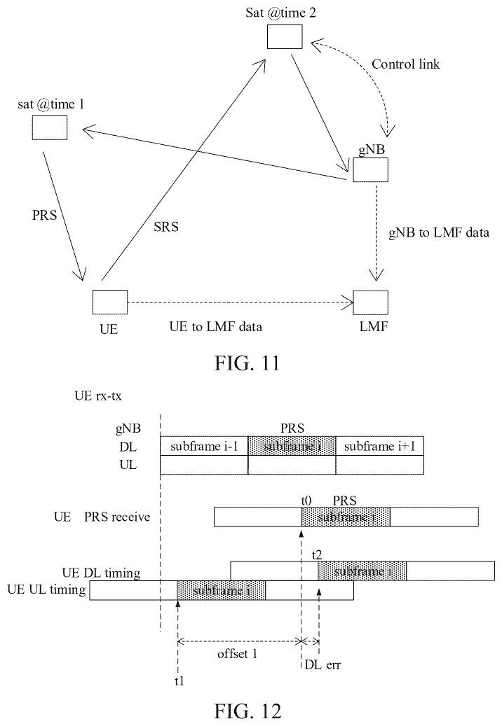

The topology of the NTN positioning is illustrated in FIG. 11, where the gNB sends one or more downlink reference signals, e.g., PRS or CSI-RS to a UE via a satellite. Then, the UE may perform the PRS/CSI-RS measurement and report the positioning assistance data to LMF. The assistance data from UE to LMF includes UE Rx-Tx time difference. Moreover, the UE may send one or more uplink reference signals, e.g., SRS to the gNB via satellite. The gNB may perform SRS measurement and report the positioning assistance data to LMF. The assistance data from gNB to LMF includes gNB Rx-Tx time difference.

UE generating assistance data to report to LMF:

When UE receives the PR, the UE derives a PRS receiving (Rx) timing, e.g. t0 and the UE determines the subframe index i of a SFN n, in which the PRS is received. Then the UE determines the UE transmit timing (Tx) of the same subframe index i of SFN n, e.g., t1. Then, the UE calculates the difference between t0 and t1 to obtain offset 1, i.e., offset 1=t0-t1.

For the assistance information reported by the UE to the LMF, at least one of the following options can be used. The UE reports the value of offset 1. The value of offset 1 is understood as the UE TA with a correction due to the DL synchronization error as illustrated in FIG. 12, where the DL synchronization error can be interpreted as time difference between t0 and t2, where t2 is the UE DL timing for the subframe i of SFN n. It is to note that the UE UL timing is NTN system is time varying, thus in our disclosure, t1 represents the UE transmit timing at the time of calculating the offset 1 or at the time of receiving the PRS.

Optionally, since the UE TA can be further composed of TA=(N_{TA}+N_{UE specific}+N_{common TA}+N_{TA offset})*Tc. Examples of the UE TA are as specified in TS38.211 V17. For NTN based positioning, what LMF needs to estimate the UE positioning is the RTT time between the UE and the satellite, i.e., the SL_delay in FIG. 10A to FIG. 10D. Thus, the UE can report the TA part corresponding to the service link, e.g., UE reports to the LMF offset 1−N_{common TA}*Tc. Here the UE removes the TA part relevant to the common TA which corresponds to the feeder link delay.

Optionally, the UE reports: offset 1−(N_{TA}+N_{common TA}+N_{TA offset})*Tc, which is equivalent to reporting only the N_{UE specific} part. Optionally, the UE may report the overall RTT to the LMF and leave LMF to further break it down to service link RTT. In this case, the UE may not only report offset 1 but also the value of Kmac, which represents the RTT between a reference point to the gateway/gNB. It is to note that the UE may report a summation of offset 1 and Kmac, or the UE may report them respectively if they have different granularity.

In some examples, when UE reports the value of offset1 or offset1−N_{common TA}*Tc or offset1−(N_{TA}+N_{common TA}+N_{TA offset})*Tc as discussed above, the UE may convert the value into at least two values: the first value is a number of first granularity and the second value is a number of second granularity. The second granularity is smaller than the first granularity in time. For example, the first granularity is one subframe or 1 or multiple milliseconds, the second granularity is Tc, where Tc is defined in TS38.211 V17. An example is that, if UE calculates the value to be reported being (480*4096+1)Tc, and given that 480*4096*Tc=1 ms, the UE may report the value of ‘1’ for the first granularity (e.g., 1 ms) and report another value of ‘1’ for the second granularity (e.g., 1Tc). With this, the UE does not need to report the value of ‘480*4096+1’, leading to a significant overhead reduction.

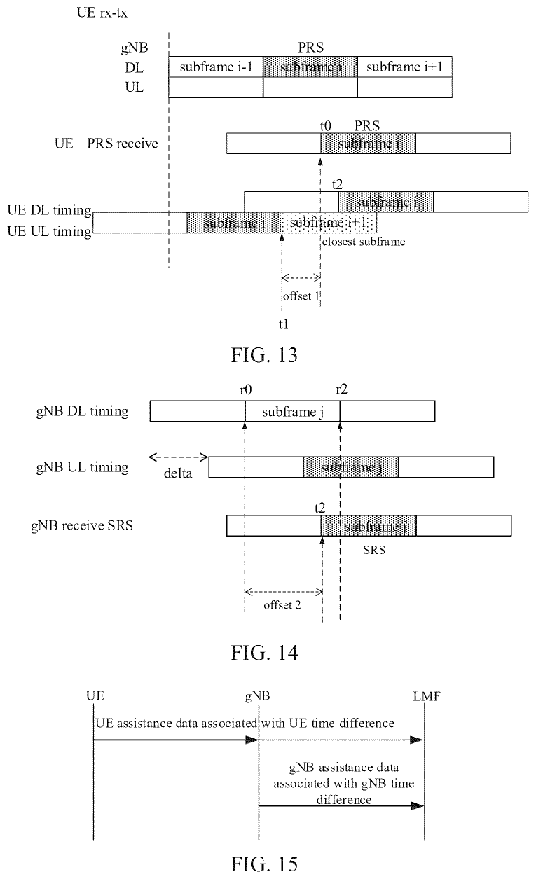

Optionally, UE determining the transmit timing t1 can select the closest UL subframe to the received PRS time to as illustrated in FIG. 13. Optionally, UE reports to the LMF at least an index of a subframe, wherein the subframe is the one the UE uses to determine t1 or the transmit timing for calculating the UE Rx-Tx time difference. For example, the subframe is the closet UL subframe to the received PRS or t0 in FIG. 13. Optionally, the UE reports to the LMF a SFN index in which the subframe is located. An example of FIG. 13, the UE reports subframe i+1 as it is the closest subframe to t0. And the UE reports SFN n as the subframe i+1 is located in SFN n. Alternatively, the subframe index can be replaced with slot index.

gNB generating assistance data to report to LMF:

From gNB side, the gNB may calculate the gNB Rx-Tx time difference and report it to LMF. The gNB side measurement is based on UL reference signal, e.g., SRS. When the gNB receives the SRS, the gNB determines the SRS receive timing r1, where the SRS is received in subframe j of SFN m. Then the gNB determines the transmit timing of the DL subframe j of SFN m, r0. The gNB may report the following assistance data to LMF. gNB reports the Rx-Tx time difference, which is equal to offset 2=r1−r0.

Optionally, in some examples, there is an offset, called delta in FIG. 9 between the gNB DL timing and UL timing. It can also be represented by Kmac. Thus, the gNB may report offset 2-Kmac or report separately offset 2 and Kmac to LMF.

Optionally, for determining the transmit timing r0, the gNB may select a subframe index for which it is the closest to r1. In this case, the gNB may report the subframe index and/or the SFN index in which the SRS is received. Optionally, the gNB may report a second subframe index and/or a SFN index in which the gNB determines the transmit timing r0.

Optionally, the gNB may report a timestamp to the LMF, wherein the timestamp represents the time when the gNB calculates the Rx-Tx time difference. Optionally, the gNB may report the ephemeris data and/or the reference point location and/or a gateway location and/or the gNB location to the LMF. Thus, the LMF can calculate precisely the feeder link delay.

FIG. 15 illustrates that, in some embodiments, the UE is configured to report a UE assistance data associated with a UE time difference to a network node and/or a base station (BS). The BS is configured to report a BS assistance data associated with a BS time difference to a network node. This can provide a system positioning, reduce a network signaling, reduce a power consumption, provide a good communication performance, and/or provide a high reliability. In other words, the network node is configured to receive a UE assistance data associated with a UE time difference from a UE; and/or receive a BS assistance data associated with a BS time difference from a BS.

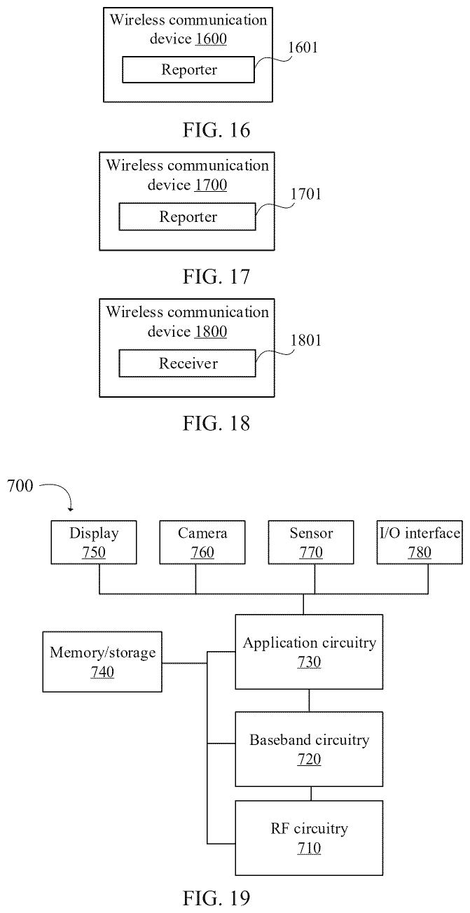

FIG. 16 illustrates a wireless communication device 1600 according to an embodiment of the present disclosure. The wireless communication device 1600 includes a reporter 1601 configured to report a UE assistance data associated with a UE time difference to a network node and/or a base station (BS). This can provide a system positioning, reduce a network signaling, reduce a power consumption, provide a good communication performance, and/or provide a high reliability.

In some embodiments, the network device includes a base station, a core network, a transmission reception point (TRP), a satellite, or a location management function (LMF). In some embodiments, the network node includes a core network, a transmission reception point (TRP), a satellite, or a location management function (LMF). In some embodiments, the method further includes generating, by the UE, the UE assistance data associated with the UE time difference. In some embodiments, generating, by the UE, the UE assistance data associated with the UE time difference includes: receiving, by the UE, a downlink reference signal (DRS) to derive a DRS receiving (Rx) timing (t0); determining, by the UE, a UE transmit (Tx) timing (t1) for transmitting uplink transmission or calculating a Rx-Tx UE time difference (offset 1); and/or calculating a difference between t0 and t1 to obtain offset 1.

In some embodiments, the DRS is in a downlink subframe of a first subframe index in a first SFN index. In some embodiments, the UE Tx timing is relevant to an uplink subframe of the first subframe index in the first SFN index; or the UE Tx timing is relevant to an uplink subframe of a second subframe index, wherein the uplink subframe of the second subframe index is in the first SFN index or in a second SFN index. In some embodiments, the uplink subframe of the second subframe index is closest in time to the UE RX timing t0. In some embodiments, the DRS is configured being associated with the TRP. In some embodiments, the TRP is associated with the satellite. In some embodiments, the TRP is associated with the satellite corresponding to a time instance, a time period, a duration, or a time interval.

In some embodiments, the DRS includes: a positioning reference signal (PRS), a synchronization signal block (SSB), or a channel state information reference signal (CSI-RS). In some embodiments, the UE assistance data associated with the UE time difference includes at least one of the following: information associated with offset 1; information associated with a UE timing advance (TA); or a relation of the information associated with offset 1 and the information associated with the UE TA. In some embodiments, the UE assistance data associated with the UE time difference includes a value of offset 1, a value of Kmac representing a round trip time (RTT) between a reference point to a gateway and/or the base station, and/or a summation of offset 1 and Kmac.

In some embodiments, the value of offset 1 is related to the UE TA with a correction. In some embodiments, the correction is related to a downlink synchronization error. In some embodiments, the downlink synchronization error includes a time difference between t0 and t2, where t2 is a UE downlink timing at downlink subframe of the first subframe index of the first SFN index. In some embodiments, the UE assistance data associated with the UE time difference includes: offset 1 minus N_{common TA} multiplied by Tc, where N_{common TA} is a common network-controlled timing correction, and Tc is a basic time for new radio (NR). In some embodiments, N_{common TA} is related to a service link delay and/or is not related to a feeder link delay.

In some embodiments, the UE assistance data associated with the UE time difference includes: N_{UE specific} or offset 1 minus (N_{TA} plus N_{common TA} plus N_{TA offset}) multiplied by Tc, where N_{UE specific} is a UE-derived timing correction, N_{TA} is a TA between downlink and uplink, N_{common TA} is a common network-controlled timing correction, N_{TA offset} is a fixed offset used to calculate the UE TA, and Tc is a basic time for new radio (NR). In some embodiments, the UE is configured to report offset 1, N_{common TA}, N_{TA offset}, and/or N_{TA} to the network node for the network node to calculate the UE assistance data associated with the UE time difference using offset 1, N_{common TA}, N_{TA offset}, and/or N_{TA}. In some embodiments, the UE assistance data associated with the UE time difference includes the first subframe index and/or the second subframe index and/or the first SFN index and/or the second SFN index. In some embodiments, the UE is configured to report the first subframe index and/or the second subframe index and/or the first SFN index and/or the second SFN index to the network node.

In some embodiments, the UE assistance data associated with the UE time difference includes a timestamp representing time when the UE determines t1 or time when the UE calculating/generating the UE assistance data. In some embodiments, the UE assistance data associated with the UE time difference includes a UE location. In some embodiments, a value of the UE assistance data associated with the UE Rx-Tx time difference includes a first value and a second value, the first value is a number of first granularity, and the second value is a number of second granularity. In some embodiments, the second granularity is smaller than the first granularity in time. In some embodiments, the first granularity is one subframe or 1 or multiple milliseconds, and the second granularity is 1 Tc or multiple Tc; where 1 millisecond is equal to 480 times 4096 Tc.

FIG. 17 illustrates a wireless communication device 1700 according to an embodiment of the present disclosure. The wireless communication device 1700 includes a reporter 1701 configured to report a BS assistance data associated with a BS time difference to a network node. This can provide a system positioning, reduce a network signaling, reduce a power consumption, provide a good communication performance, and/or provide a high reliability.

In some embodiments, the network node includes a core network, a transmission reception point (TRP), a satellite, or a location management function (LMF). In some embodiments, the method further includes generating, by the BS, the BS assistance data associated with the BS time difference. In some embodiments, generating, by the BS, the BS assistance data associated with the BS time difference includes: receiving, by the BS, an uplink reference signal (URS) to derive a URS receiving (Rx) timing (r1); determining, by the BS, a BS transmit (Tx) timing (r0) for transmitting downlink transmission or calculating a Rx-Tx BS time difference (offset 2); and/or calculating a difference between r1 and r0 to obtain offset 2. In some embodiments, the URS is in an uplink subframe of a first subframe index in a first SFN index.

In some embodiments, the BS Tx timing is relevant to a downlink subframe of the first subframe index in the first SFN index; or the BS Tx timing is relevant to a downlink subframe of a second subframe index, wherein the downlink subframe of the second subframe index is in the first SFN index or in a second SFN index. In some embodiments, the downlink subframe of the second subframe index is closest to the BS Rx timing (r1). In some embodiments, the URS is configured being associated with the TRP. In some embodiments, the TRP is associated with the satellite. In some embodiments, the TRP is associated with the satellite corresponding to a time instance, a time period, a duration, or a time interval. In some embodiments, the URS includes a sounding reference symbol (SRS), a physical random access channel (PRACH), a physical uplink control channel (PUCCH), or a physical uplink shared channel (PUSCH).

In some embodiments, the BS assistance data associated with the BS time difference includes at least one of the following: information associated with offset 2; information associated with an offset between BS downlink timing and uplink timing (delta); or a relation of the information associated with offset 2 and the information associated with delta. In some embodiments, the BS assistance data associated with the BS time difference includes a value of offset 2, a value of delta, and/or a summation of offset 2 and delta. In some embodiments, the BS assistance data associated with the BS time difference includes the first subframe index and/or the second subframe index and/or the first SFN index and/or the second SFN index. In some embodiments, the BS assistance data associated with the BS time difference includes a timestamp representing time when the BS determines r0.

In some embodiments, the BS assistance data associated with the BS time difference includes an ephemeris data, a reference point location, a gateway location, and/or a BS location. In some embodiments, a value of the BS assistance data associated with the BS Rx-Tx time difference includes a first value and a second value, the first value is a number of first granularity, and the second value is a number of second granularity. In some embodiments, the second granularity is smaller than the first granularity in time. In some embodiments, the first granularity is one subframe or 1 or multiple milliseconds, and the second granularity is Tc, wherein Tc is a basic time for new radio (NR).

FIG. 17 illustrates a wireless communication device 1800 according to an embodiment of the present disclosure. The wireless communication device 1800 includes a receiver 1801 configured to receive a UE assistance data associated with a UE time difference from a UE; and/or receive a BS assistance data associated with a BS time difference from a BS. This can provide a system positioning, reduce a network signaling, reduce a power consumption, provide a good communication performance, and/or provide a high reliability.

Commercial interests for some embodiments are as follows. 1. Providing a system positioning. 2. Reducing a network signaling. 3. Reducing a power consumption. 4. Providing a good communication performance. 5. Providing a high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in 5G NR licensed and non-licensed or shared spectrum communications. Some embodiments of the present disclosure propose technical mechanisms.

FIG. 19 is a block diagram of an example system 700 for wireless communication according to an embodiment of the present disclosure. Embodiments described herein may be implemented into the system using any suitably configured hardware and/or software. FIG. 19 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A user equipment (UE) for wireless communication, comprising:
a memory;
a transceiver; and
a processor coupled to the memory and the transceiver;
wherein the UE is configured to report a UE assistance data associated with a UE time difference to a network node and/or a base station (BS).

2. The UE according to claim 1, wherein the UE is further configured to:
receive a downlink reference signal (DRS) to derive a DRS receiving (Rx) timing (t0);
determine a UE transmit (Tx) timing (t1) for transmitting uplink transmission or calculating a Rx-Tx UE time difference (offset 1); and/or
calculate a difference between t0 and t1 to obtain offset 1.

3. The UE according to claim 2, wherein the DRS is in a downlink subframe of a first subframe index in a first SFN index; and/or the UE Tx timing is relevant to an uplink subframe of the first subframe index in the first SFN index; or the UE Tx timing is relevant to an uplink subframe of a second subframe index, wherein the uplink subframe of the second subframe index is in the first SFN index or in a second SFN index; and/or the uplink subframe of the second subframe index is closest in time to the UE RX timing to.

4. The UE according to claim 2, wherein the UE assistance data associated with the UE time difference comprises at least one of the following:
information associated with offset 1;
information associated with a UE timing advance (TA); or
a relation of the information associated with offset 1 and the information associated with the UE TA.

5. The UE according to claim 4, wherein the UE assistance data associated with the UE time difference comprises a value of offset 1, a value of Kmac representing a round trip time (RTT) between a reference point to a gateway and/or the base station, and/or a summation of offset 1 and Kmac.

6. The UE according to claim 5, wherein the value of offset 1 is related to the UE TA with a correction, the correction is related to a downlink synchronization error, the downlink synchronization error includes a time difference between t0 and t2, where t2 is a UE downlink timing at downlink subframe of the first subframe index of the first SFN index.

7. The UE according to claim 4, wherein the UE assistance data associated with the UE time difference comprises: offset 1 minus N_{common TA} multiplied by Tc, where N_{common TA} is a common network-controlled timing correction, and Tc is a basic time for new radio (NR).

8. The UE according to claim 7, wherein N_{common TA} is related to a service link delay and/or is not related to a feeder link delay.

9. The UE according to claim 4, wherein the UE assistance data associated with the UE time difference comprises: N_{UE specific} or offset 1 minus (N_{TA} plus N_{common TA} plus N_{TA offset}) multiplied by Tc, where N_{UE specific} is a UE-derived timing correction, N_{TA} is a TA between downlink and uplink, N_{common TA} is a common network-controlled timing correction, N_{TA offset} is a fixed offset used to calculate the UE TA, and Tc is a basic time for new radio (NR).

10. The UE according to claim 9, wherein the UE is configured to report offset 1, and/or N_{common TA}, and/or N_{TA offset}, and/or N_{TA} to the network node.

11. The UE according to claim 4, wherein the UE assistance data associated with the UE time difference comprises the first subframe index and/or the second subframe index and/or the first SFN index and/or the second SFN index; or
the UE assistance data associated with the UE time difference comprises a timestamp representing time when the UE determines t1 or time when the UE calculating/generating the UE assistance data; or
the UE assistance data associated with the UE time difference comprises a UE location.

12. The UE according to claim 4, wherein a value of the UE assistance data associated with the UE Rx-Tx time difference comprises a first value and a second value, the first value is a number of first granularity, and the second value is a number of second granularity.

13. The UE according to claim 12, wherein the second granularity is smaller than the first granularity in time, and/or the first granularity is one subframe or 1 or multiple milliseconds, and the second granularity is 1 Tc or multiple Tc; where 1 millisecond is equal to 480 times 4096 Tc.

14. A base station (BS) for wireless communication, comprising:
a memory;
a transceiver; and
a processor coupled to the memory and the transceiver;
wherein the BS is configured to report a BS assistance data associated with a BS time difference to a network node.

15. The BS according to claim 14, wherein the BS is further configured to:
receive an uplink reference signal (URS) to derive a URS receiving (Rx) timing (r1);
determine a BS transmit (Tx) timing (r0) for transmitting downlink transmission or calculating a Rx-Tx BS time difference (offset 2); and/or
calculate a difference between r1 and r0 to obtain offset 2.

16. The BS according to claim 15, wherein the URS is in an uplink subframe of a first subframe index in a first SFN index; and/or the BS Tx timing is relevant to a downlink subframe of the first subframe index in the first SFN index; or the BS Tx timing is relevant to a downlink subframe of a second subframe index, wherein the downlink subframe of the second subframe index is in the first SFN index or in a second SFN index; and/or the downlink subframe of the second subframe index is closest to the BS Rx timing (r1).

17. The BS according to claim 15, wherein the BS assistance data associated with the BS time difference comprises at least one of the following:
information associated with offset 2;
information associated with an offset between BS downlink timing and uplink timing (delta); or
a relation of the information associated with offset 2 and the information associated with delta.

18. The BS according to claim 17, wherein the BS assistance data associated with the BS time difference comprises a value of offset 2, a value of delta, and/or a summation of offset 2 and delta; or
the BS assistance data associated with the BS time difference comprises the first subframe index and/or the second subframe index and/or the first SFN index and/or the second SFN index; or
the BS assistance data associated with the BS time difference comprises a timestamp representing time when the BS determines r0; or
the BS assistance data associated with the BS time difference comprises an ephemeris data, a reference point location, a gateway location, and/or a BS location.

19. The BS according to claim 17, wherein a value of the BS assistance data associated with the BS Rx-Tx time difference comprises a first value and a second value, the first value is a number of first granularity, and the second value is a number of second granularity.

20. A network node, comprising:
a memory;
a transceiver; and
a processor coupled to the memory and the transceiver;
wherein the transceiver is configured to receive a UE assistance data associated with a UE time difference from a UE and/or receive a BS assistance data associated with a BS time difference from a BS.
